(19) United States
(12) Patent Application Publication
(10) Pub. No.: US 2002/0149282 A1
(43) Pub. Date: Oct. 17, 2002

(54) Stator

(76) Inventor: Markus Heidrich, Buehl (DE)

Correspondence Address: Michael J Striker, Striker Striker & Stenby, 103 East Neck Road, Huntington, NY, 11743, US

(21) Appl. No.: 10/031,829

(22) PCT Filed: May 4, 2001
(86) PCT No.: PCT/DE01/01666

(30) Foreign Application Priority Data
May 6, 2000 (DE) 100 22 071.1

(51) Int. Cl. H02K 1/18

(52) U.S. Cl. 310/218

(57) ABSTRACT

A stator according to the related art comprises preassembled coils that are slid onto stator pole teeth and secured to the respective stator pole tooth by means of a single part.

This has the disadvantage, however, that a magnetic flux in the winding head of the exciting coil cannot be directed in defined fashion.

A stator according to the invention comprises at least one pole shoe (15) that secures a coil (11) on a stator pole tooth (7).

### RELATED ART

The invention is based on a stator according to the definition of the species in claim 1.

A stator has already been made known in U.S. Pat. No. 5,089,730, onto the stator pole teeth of which a preassembled coil is slid. The coils are secured to the stator pole teeth by means of a single part.

This has the disadvantage, however, that a magnetic flux in the winding head of the exciting coil cannot be directed in defined fashion, and therefore does not contribute to the torque of the rotor, nor is there a gap in the foot of the tooth.

### ADVANTAGES OF THE INVENTION

In contrast, the stator according to the invention having the characterizing features in claim 1 has the advantage that a stator can be produced in simple fashion that makes smaller tolerances possible and has improved performance data, such as a higher slot fill factor of the excitation coils, less space required to install the motor, reduced stop torques, and higher torque, for example.

Advantageous further developments and improvements of the stator named in claim 1 are possible due to the measures listed in the dependent claims.

It is advantageous that a pole shoe is made of magnetically soft solid material, because a magnetic stray flux of a winding head of an exciting coil can then be directed in all spacial directions in defined fashion and contribute to the magnetic excitation.

It is further advantageous that a coil insulating frame is located on the pole shoe, because a coil can then be wound in simple fashion.

A coil can be electrically connected to an external power source or electrical control in advantageous fashion if an electrical connecting element is integrated in the coil insulating frame.

### BRIEF DESCRIPTION OF THE DRAWING

Simplified versions of the exemplary embodiments of the invention are shown in the drawing and described in greater detail in the subsequent description.

FIG. 1 shows a first exemplary embodiment of a stator designed according to the invention,

FIG. 2 shows a pole shoe,

FIG. 3 shoes an oblong pole shoe,

FIG. 4 shows an oblong pole shoe having a coil frame.

### DETAILED DESCRIPTION OF THE EXEMPLARY EMBODIMENTS

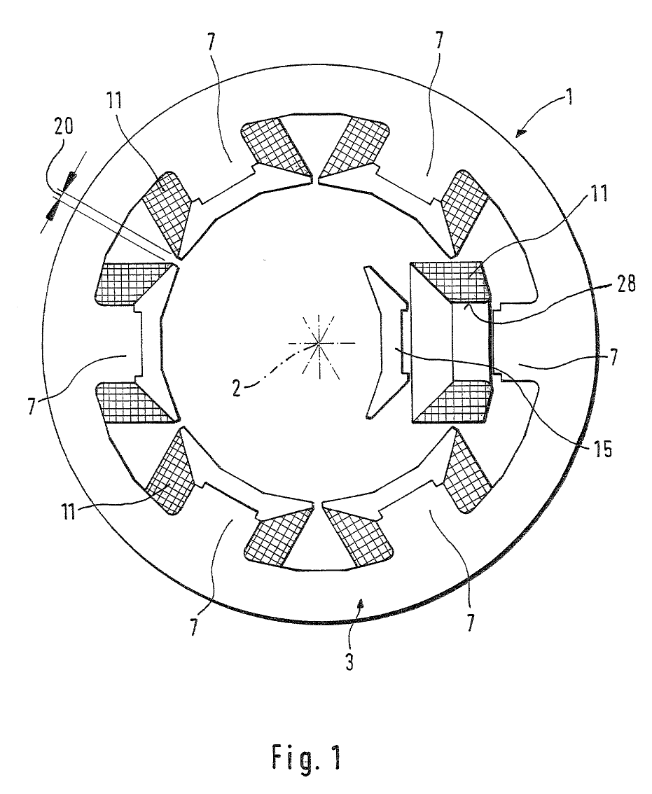

FIG. 1 shows a stator 1, according to the invention, of an electrical machine, such as an internal rotor motor, for example. The stator 1 is formed by a stator ring 3 that comprises at least one stator pole tooth 7 and a centerline 2. The stator ring 3 is made of a solid material, or it is laminated. The, e.g., six stator pole teeth 7 present, extending radially inward, are distributed evenly around the centerline 2.

A coil 11 is slid onto each stator pole tooth 7. These are preassembled coils 11, for example, e.g., “stoved-enamel” coils, or they are coils 11 wound onto a coil frame 28. The coils 11 can also be compound coils.

Each coil 11 is secured to the stator pole tooth 7 by means of one pole shoe 15. Each exposed end of a stator pole tooth 7 and each pole shoe 15 is designed in such a fashion, for example, that a press fit is produced when joined. Any other type of mounting is feasible.

A stator 1 is achieved as a result, the inner diameter of which has a maximum tolerance of 0.05 mm between opposite pole shoes 15.

During assembly, the pole shoes 15 are placed on the stator pole teeth 7 and fixed sufficiently on the stator pole teeth 7 using a mandrel inserted in the direction of the centerline 2, and centered in relation to the centerline 2.

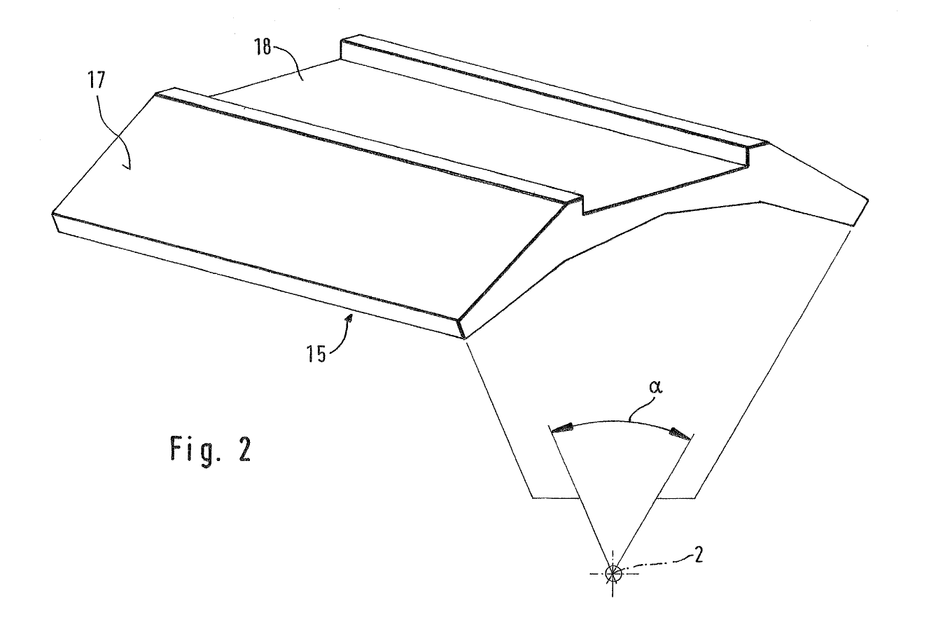

FIG. 2 shows a pole shoe 15.

The pole shoe 15 comprises a groove 18 on an exterior surface 17, by means of which it is pressed onto the exposed end of the stator pole tooth 7, so that a press fit is produced. Magnetically soft material—“SMC” or “SMS” material—can be used as the material for the pole shoe 15 that is easy to manufacture and shape using pressing technology.

A stator according to the related art consists of stacks of individual laminations. It requires considerable expenditure to manufacture a laminated pole shoe out of individual laminations, however.

An opening angle α encompassing the length of the pole shoe 15 in the circumferential direction around the centerline 2 can therefore be enlarged compared with the related art, which makes a gap in the foot of the tooth 20 (FIG. 1) smaller in size, and a stop torque for a transition between two detent positions is therefore reduced, because magnetic resistance is reduced due to a smaller gap in the foot of the tooth 20.

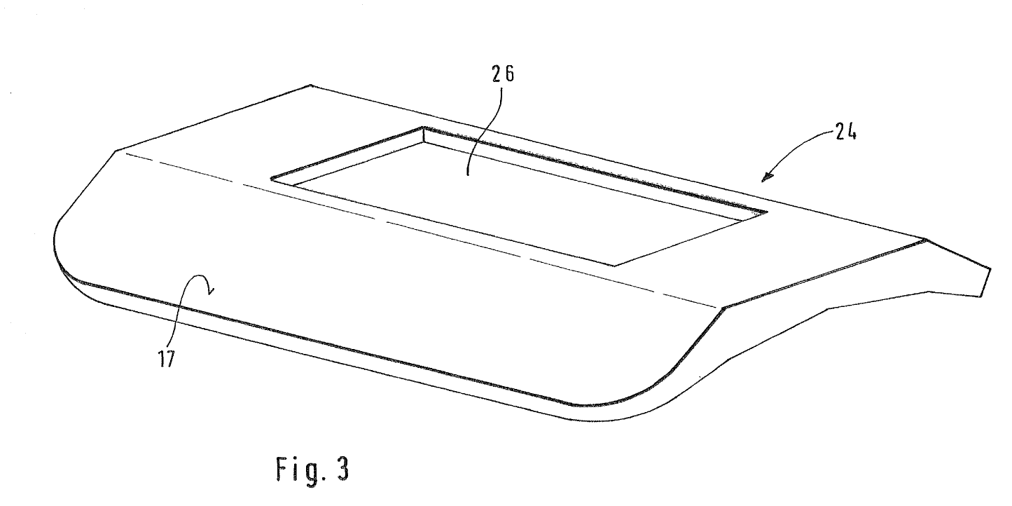

FIG. 3 shows an oblong pole shoe 24.

The oblong pole shoe 24 is a pole shoe 15 that is longer in both axial directions than an exemplary embodiment according to FIG. 2, the groove 18 of which oblong pole shoe 24 is closed on both ends by the extension and forms an indentation 26.

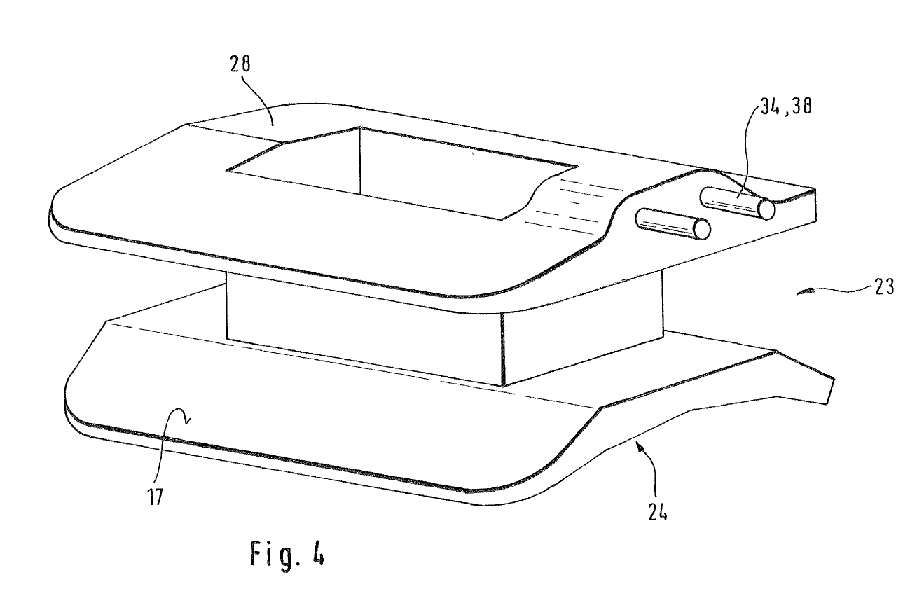

FIG. 4 shows an oblong pole shoe 24 on which the coil frame 28 is located.

The coil frame 28 is integrally extruded on the oblong pole shoe 24 using plastic, for example. Undercuts, for example, are provided in the pole shoe 15 or the oblong pole shoe 24, i.e., a snap-in connection with the pole tooth 7 is formed, so that the coil frame 28 is fixed in position on the pole tooth 7.

A coil 11 is wound on the coil frame 28 that can be inspected before installation on the stator ring 3, i.e., only inspected coils 11 are installed. Therefore, a stator 1 that tests out poorly that comprises coils 11 wired together need not be thrown out entirely due to one bad coil 1.

One part of the coil 11 (not shown) in a winding head space 23 is located on one axial end of the coil frame 28. The oblong pole shoe 24 makes it possible to direct a magnetic stray flux of an exciting coil 11 in defined fashion in the region of the winding head space 23 of the coil 11 as well, and therefore also contributes to the torque when a rotor is dimensioned accordingly.

The coil frame 28 also provides electrical insulation for the coil 11 from the pole tooth 7 and/or the pole shoe 15 or the oblong pole shoe 24. The coil frame 28 comprises at least one electrical connecting element 34 that serves to contact at least one end of a coil 11 with an external power supply. In this exemplary embodiment, the electrical connecting elements 34 are formed by two pins 38 located in the coil frame 28. The electrical connecting element 34 can also be an insulation displacement connection.

What is claimed is:

1. A stator (1), in particular for an electrical internal rotor motor,
comprising at least one stator pole tooth (7),
comprising at least one preassembled coil (11) that is slid onto the stator pole tooth (7) and secured to it,
wherein
the coil (11) is secured to the stator pole tooth (7) by means of a pole shoe (15).

2. The stator according to claim 1,
wherein
a coil form (28) is located on the pole shoe (15).

3. The stator according to claim 1 or 2,
wherein
the pole shoe (15) is made of a magnetically soft solid material.

4. The stator according to one or more of the claims 1 through 3,
wherein
the coil form (28) is integrally extruded on the pole shoe (15).

5. The stator according to claim 3 or 4,
wherein
the coil form (28) comprises at least one electrical connecting element (34).

6. The stator according to claim 5,
wherein
the electrical connecting element (34) is a pin (38).

7. The stator according to one or more of the claims 1 through 4,
wherein
the pole shoe (15) is secured to the stator pole tooth (7) by means of press fit.
